(19) United States
(12) Patent Application Publication
(10) Pub. No.: US 2010/0315898 A1
(43) Pub. Date: Dec. 16, 2010

(54) FEED MIXER

(75) Inventor: Cornelis Hendricus Liet, Losser (NL)

Correspondence Address: FISH & RICHARDSON P.C. (NY), P.O. BOX 1022, MINNEAPOLIS, MN, 55440-1022, US

(73) Assignee: TRIOLIET HOLDING B.V., Oldenzaal (NL)

(21) Appl. No.: 12/813,795

(22) Filed: Jun. 11, 2010

(30) Foreign Application Priority Data
Jun. 15, 2009 (DE) 202009008215.6

(51) Int. Cl. B01F 15/00

(52) U.S. Cl. 366/280

(57) ABSTRACT

A feed mixer (1, 101, 201) is described, which comprises a mixing container (4) provided with a container wall (6) having an opening (7) delimited by an edge. Said opening (7) has associated therewith a retaining means (9, 109, 209). In order to configure the feed mixer such that, without any increase in the passage height, the feed will be prevented from dropping out, it is suggested that the retaining means (9, 109, 209) should be provided with a retaining lip (10, 110, 210) which consists of an elastically flexible material and which extends, at least in certain sections thereof, inwards and projects beyond the opening (7).

The present invention relates to a feed mixer of the type specified in the preamble of claim 1.

Such a feed mixer is known from DE 201 07 602 U1. The known feed mixer is implemented as a feed mixing vehicle and comprises a mixing container with a mixing tool disposed therein. The mixing container is completely open on the side facing upwards so that it can be charged through this opening. The mixing tool is a mixing screw rotating about a perpendicular axis such that the feed charged into the container is conveyed upwards and drops then down onto the bottom of the container. This guarantees that the feed is mixed well and loosened. However, the fact that the feed is conveyed vertically upwards by the mixing screw entails the risk that the feed may be squeezed upwards and out of the opening. In order to prevent this, the known feed mixer comprises a retaining means consisting of a loose ring which, by means of flexible holding elements, such as chains, is secured to the upper edge of the container wall in such a way that, when no load is applied to the ring, it will hang into the container and reduce the size of the opening in the interior of the container. This entails the risk that feed may accumulate on the upper surface of the ring and on the upper surface of the chains and may then be squeezed out of the container, when the mixing screw is in operation and the feed is pushed upwards and against the ring from below and lifts the ring beyond the container wall. In addition, it may happen that feed gets stuck between the ring and the container wall and distorts the ring.

In addition, it is also known, e.g. from DE 199 02 173 C2, to provide structural parts on the upper edge of the container, said structural parts being pivotably secured to the container edge. When the feed mixer is being charged, the structural parts project substantially horizontally into the opening and are then caused to assume an upright position by the feed pushed upwards by the mixing element. Also in this case, there is the risk that, during the charging operation, feed will accumulated on the structural parts, which will then fall out of the container when said structural parts assume an upright position. A pivotable arrangement is, however, required so as to avoid the necessity of increasing, especially in the case of mobile feed mixers, the passage height that has to be observed when the feed mixer passes through doors or the like.

It is the object of the present invention to provide a feed mixer which, without any increase in the passage height, prevents the feed from falling out.

This object is achieved by the features specified in claim 1.

The structural design according to the present invention enlarges the volume of the mixing container towards the top without simultaneously increasing the passage height, since, if the feed mixer should pass through particularly low doors, the retaining lip made of elastic material can be pushed away. The oblique mode of arrangement reduces the risk that feed may accumulate on the retaining means during the charging operation and get lost on the way later on. Nevertheless, the retaining lip, which is directed upwards and inwards, offers a sufficiently high, but resilient resistance which will prevent the feed from dropping out, when the latter is pushed upwards by the mixing tool. The risk of damage being caused to the retaining means and/or the risk of feed getting stuck are thus reduced to a substantial extent. In addition, the retaining means also acts as a guiding surface which returns the upwardly migrating feed downwards and inwards This will improve the mixing efficiency.

Advantageous further developments of the invention are disclosed in the subclaims.

Depending on the shape and the inclination of the container wall, the retaining lip should, at least in certain sections thereof, extend at an angle deviating from 90°.

According to a preferred embodiment, the retaining lip extends annularly around the whole edge of the container wall, but it may also be limited to certain sections, when, e.g. due to the nature and the mode of arrangement of the mixing tool, the risk that feed will be pushed over the edge in the course of the mixing operation does not exist everywhere.

Production and fastening of the retaining lip will be improved, when said retaining lip is configured such that it comprises a plurality of sections which are connected to one another with motion compensation.

The retaining lip can have any shape, but preferably it is configured either as a plain, flat strip or as a profile strip having a profile formed therein.

When the mixing container has a curved opening, it will facilitate the mounting and the function of the retaining lip, when said retaining lip is, at least in certain sections thereof, configured as part of an envelope of a cone.

In order to accomplish, especially in the case of long, straight edge portions of the opening, an effective support for the retaining lip, so as to prevent the latter from dropping into the opening, the retaining lip is, at least in certain sections thereof, acted upon by a spring element.

A further reinforcement of the retaining lip is accomplished, without impairing the function of said retaining lip, when the free end of the retaining lip is provided with a reinforcing means.

The retaining lip is fixed to the container wall preferably via a fastening means, said fastening means being preferably releasable so as to allow a replacement of worn retaining lips, if this should be necessary.

The retaining lip preferably rests on a support surface guaranteeing the correct angular position of the retaining lip on the one hand, and providing a certain amount of mechanical strength on the other.

Embodiments of the present invention will be explained in more detail hereinbelow with reference to the drawings, in which:

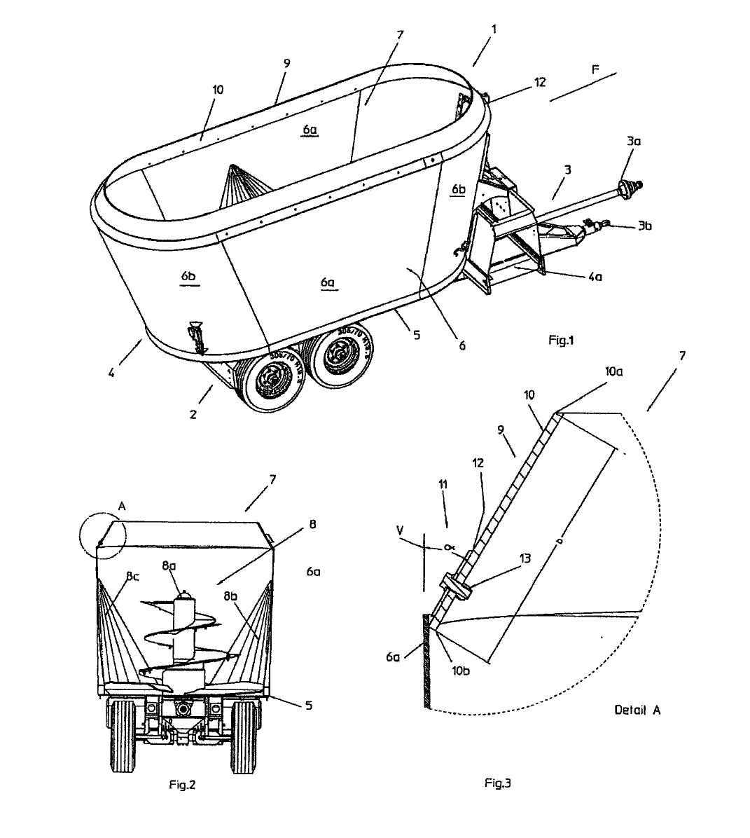

FIG. 1 shows a perspective, schematic representation of a first embodiment of a feed mixer according to the present invention,

FIG. 2 shows a cross-section through the feed mixer according to FIG. 1,

FIG. 3 shows an enlarged view of detail A according to FIG. 2,

FIG. 4 shows a perspective, schematic representation of a further embodiment of a feed mixer according to the present invention,

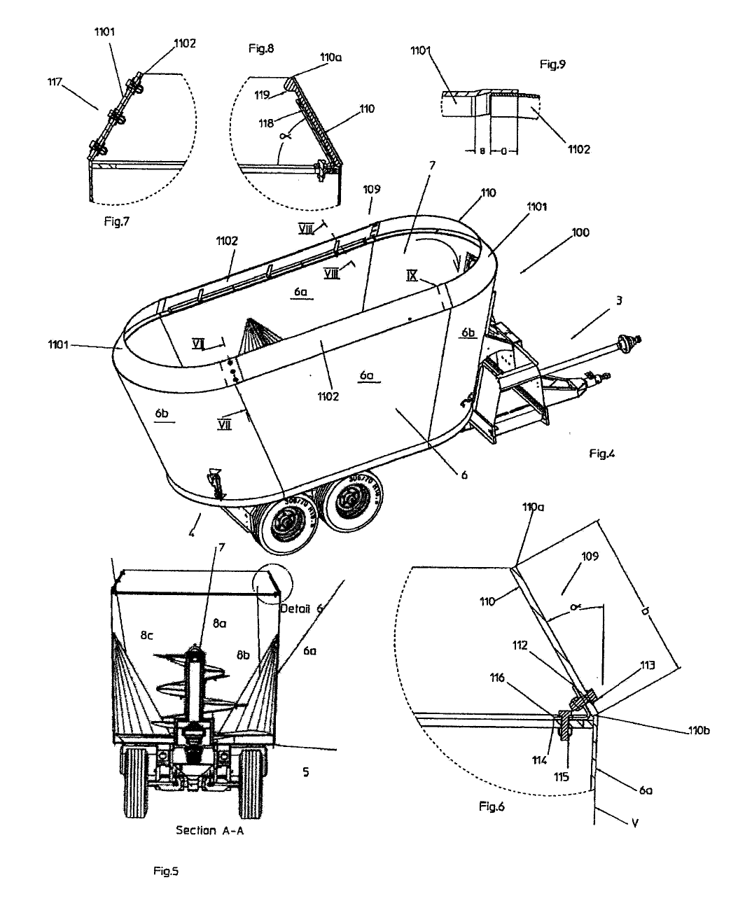

FIG. 5 shows the cross-section through the feed mixer according to FIG. 4,

FIG. 6 shows an enlarged view of detail B according to FIG. 2,

FIG. 7 shows section VII-VII according to FIG. 4,

FIG. 8 shows section VIII-VIII according to FIG. 4,

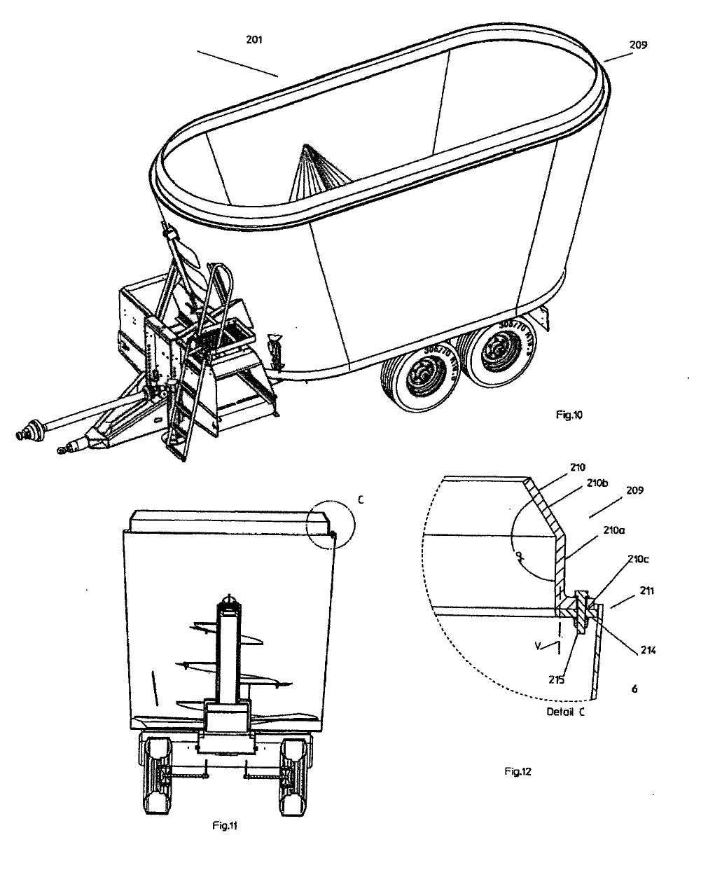

FIG. 9 shows the view in the direction of arrow IX according to FIG. 4,

FIG. 10 shows a perspective, schematic representation of a further embodiment of a feed mixer according to the present invention,

FIG. 11 shows a cross-section through the feed mixer according to FIG. 10, and

FIG. 12 shows an enlarged view of detail C according to FIG. 11.

FIG. 1 shows a schematic, perspective representation of a feed mixer 1 which, in the embodiment shown, is implemented as a feed mixing vehicle and which comprises an undercarriage 2 as well as a draw unit 3 comprising a drive transmitting unit 3a and a drawbar 3b for connection to a tractor. The invention may, however, also be used for other feed mixers.

The feed mixer 1 additionally comprises a mixing container 4 including a bottom 5 and a wall 6, which extends upwards from the bottom 5 and which, as can also be seen in FIG. 2, comprises lateral wall components 6a extending in the direction of travel F and substantially at right angles to the bottom 5. The wall components 6b extending transversely to the direction of travel F have a substantially semicircular curvature and extend vertically to the bottom 5 or such that they are inclined at an oblique angle to the bottom 5 upwards and outwards. On the upper side facing away from the bottom 5, a filler opening 7 is provided, which extends substantially across the whole upper side of the mixing container 4. On the side facing the draw unit 3, a discharge conveyor 4a is provided.

In the interior of the mixing container 4, a mixing unit 8 is provided, comprising, in the embodiment shown, two mixing screws 8a which are arranged in succession, when seen in the direction of travel F, such that their axes of rotation extend substantially at right angles to the bottom 5 and which are separated by guide members 8b, 8c, said guide members 8b, 8c being conical in shape and engaging the crotch between the operating circuit of the two mixing screws 8a. By means of the mixing unit 8, the feed, which is filled into the mixing container 4 through the opening 7, is transported in the usual way from the bottom 5 upwards in the direction of the opening 7. This has the effect that the feed, especially forage, is loosened and mixed.

In order to prevent the feed from being squeezed upwards and out of the mixing container 4 through the opening 7 due to the mixing movement, the opening 7 has associated therewith a retaining means 9. The retaining means 9 comprises a retaining lip 10 consisting of an elastically flexible material, preferably a rubber material or some suitable plastic material. In the embodiment according to FIGS. 1 to 3, the retaining lip 10 is implemented as a plain strip and is, preferably annularly, fastened to the upper edge of the container wall 6 around the opening 7. In order to facilitate fastening, especially on the curved end faces 6b of the wall 6, the retaining lip 10 can be preformed as part of an envelope of a (frustrated) cone and provided in rolled-up form. It is, however, also possible that only the sealing lip which is to be provided on the curved end faces 6b is implemented as part of the envelope of a cone, and that the sealing lip in the area of the substantially vertical, straight sides 6a of the container wall 6 is provided in the form of simple, flat and straight strips.

The retaining means 9 additionally comprises a fastening means 11 with the aid of which the retaining lip 10 is fastened to the container wall 6. The retaining lip 10 abuts on a support surface 12 in the form of a sheet-metal strip or the like extending, in the embodiment shown, over approximately the lower fifth (fourth) to third of the overall width b of the retaining lip 10. The support surface 12 should be chosen such that the upwardly directed free end 10a of the retaining lip 10 can move freely, whereas the lower end 10b of the retaining lip 10 is essentially fixed. The retaining lip 10 extends under an angle α relative to the vertical V that extends parallel to the axis of rotation of the mixing screw 8a. By means of this angle or by means of other suitable measures, it is accomplished that the retaining lip 10 extends inwards, and is preferably inclined at an oblique angle to the mixing container 4 upwards and inwards, and that it extends up to and beyond the opening 7. This angle α is preferably predetermined by the support surface 12, which is fixedly connected, e.g. welded to the container wall 7 under the angle α. This angle is preferably an angle between 10° and 50°, in particular between 20° and 40°, in particular between 25° and 35°, and in particular it is an angle of 30°. It is not absolutely necessary that the angle α does not vary along the whole edge of the opening 7. For example, the angle in the area of the straight, vertical sides 6a may differ from the angle in the area of the curved and inclined end faces 6b.

The support surface 12 is preferably implemented as part of the fastening means 11 and includes e.g. a pin 13 provided with a head, the retaining lip 10 being replaceably buttoned onto said head. Other releasable or permanent fastening possibilities for the retaining lips 10 are, however, possible as well.

In view of the elastic, resiliently flexible implementation of the retaining lip 10, said retaining lip 10 can project permanently beyond the upper edge of the container wall 6 and is simply pushed away, when the feed mixer passes through low door openings. Due to the oblique positioning, feed which may miss the opening during charging can slide down already at the charging site, and can then be returned to the supply. It follows that, when the feed mixer 1 is being moved, the path of movement can be kept clean. If feed is squeezed upwards towards the opening 7, it will be rerouted upwards and inwards by the retaining means 10 and returned into the mixing container 4. In addition, the retaining lip 10 can elastically yield outwards, if the pressure applied by the feed should become excessively strong, without any feed getting stuck between the mixing screw and the retaining lip 10.

FIGS. 4 to 6 describe a further embodiment of a feed mixer 100 according to the present invention, which differs from the feed mixer 1 only with respect to a modified retaining means 109. The other components correspond to those of conventional feed mixers, the parts corresponding to those of the first embodiment being designated by the same reference numerals and being not explained once more.

The retaining means 109 of the feed mixer 100 comprises again a retaining lip 110 consisting of a flat, plain strip made of an elastically flexible material, said strip being preferably implemented as part of the envelope of a cone. The differences in comparison with the first embodiment reside in the fastening means 111 comprising here a fastening flange 114, which extends around the opening 7 or which may also be provided only along certain sections thereof. The fastening flange 114 projects substantially horizontally from the wall 6 and is preferably welded to said wall. An angle rail 116, which is provided with the support surface 112, is secured to the fastening flange 114 with the aid of fastening elements 115. Also the support surface 112 extends between a fifth and a third of the width b of the retaining lip 110 and supports the lower end 110b of the retaining lip 110 at a predetermined angle α. Also the retaining lip 110 is releasably attached with the aid of head bolts 113.

Although FIGS. 7 to 9 refer to the embodiment according to FIG. 4, the further developments described therein can be provided in the case of all embodiments.

As can be seen from FIGS. 7 to 9, the retaining lip 110 may consist of a plurality of sections 1101 and 1102. In the embodiment shown, these sections are selected in accordance with the contour of the edge of the opening 7. For example, the sections 1101 of the retaining lip 110 associated with the curved wall areas 6b have the shape of the envelope of a cone, whereas the sections 1102 associated with the straight wall areas 6a are configured as straight strips. The individual sections 1101 and 1102 are arranged such that they overlap in the direction of rotation of the mixing tool 8a so as to prevent feed from being forced in between the sections due to the rotation. The two sections are fastened to one another via motion compensating means allowing a movement of the sections relative to one another, when the retaining lip rises in response to the pressure applied by the feed pressed against the retaining lip from below, or when said retaining lip is lowered, e.g. when the feed mixer is travelling through a low archway. One possibility of forming the motion compensating means are simple overlaps Ü of sufficient length (FIG. 9), the outer section 1101 being here deflected by an amount corresponding to the thickness of the inner section 1102, so that, with the exception of a small area B following the overlap Ü, both sections 1101 and 1102 are oriented such that they are in alignment with one another.

As can be seen in FIG. 7, the motion compensating means may also be defined by fastening means 117 consisting of screws, plug connections or connectors or the like engaging elongated holes provided in either only one or in both sections. The elongate holes extend in a direction parallel to the edge of the opening 7, so that the two sections 1101 and 1102, which abut on one another and overlap each other, can move relative to one another.

The retaining lip 110 can be supported by a spring element 118, in particular at locations where the deformation forces caused by a configuration having the shape of the envelope of a cone do not suffice, or in straight areas of the opening 7. The spring element 118 is connected to the retaining lip 110 in such a way that it prevents the retaining lip 110 from dropping into the opening with its free end 110a, i.e. the spring element 118 serves to substantially maintain the angle α even if the internal stress of the retaining lip should not suffice to do so. To this end, the spring element 118 is arranged on the inner side of the retaining lip 110 in the embodiment shown, and it abuts loosely on said retaining lip 110. In the embodiment shown, the spring element 118 comprises a plurality of strip-shaped leaf springs extending from the fastening flange 114 upwards at an angle α, said leaf springs extending over a distance corresponding to substantially three quarters of the width up to the whole width b of the retaining lip 110. Since the spring elements 118 are able to elastically yield in the same way as the retaining lip 110, the function will not be impaired. Instead of the leaf springs, other spring elements, such as coil springs or the like, may be provided. It is also possible to provide a spring suspension for the retaining lip by means of externally attached spring elements.

The retaining lip 110 can be reinforced still further by reinforcing elements 119 provided preferably in the area of the free end 110a of the retaining lip 110. The reinforcement can be provided on the inner and/or outer side of the retaining lip 110, when seen relative to the opening 7. The reinforcing means can e.g. be portions of increased thickness of the retaining lip 10, a profiled edge (corrugations), cord inserts, rope inserts or an elastic belt, a cable or the like. In addition, the reinforcing elements may be implemented as adjustable elements so that the tension at the free edge 110a can be varied, e.g. in that suitable reinforcing elements, such as a belt or a cable, are loosely conducted in rings on the free edge 110a and in that these elements are configured such that their length can be varied by means of suitable tensioning elements.

FIGS. 10 to 12 show a further embodiment of the feed mixer 201 according to the present invention having, with the exception of the retaining means 209, a conventional structural design and corresponding e.g. to the preceding embodiments. As can especially be seen from FIG. 12, the retaining means 209 comprises a modified retaining lip 210, which is here configured as a profile strip including a cylindrical area 210a that extends substantially vertically. The upper end of the cylindrical area 210a is followed by an oblique area 210b having preferably the shape of the envelope of a cone and including the angle α with the cylindrical area 210a. The retaining lip 210 has, at the lower end thereof, a fastening flange 210c with which it is fixed to a fastening flange 214 by means of fastening elements 215. The fastening flange 214 is preferably secured to the container wall 6, preferably around the opening 7, e.g. by means of welding, and extends substantially horizontally.

The present invention can, in the form of modifications of the embodiments described hereinbefore and shown in the drawings, be used for feed mixers of any kind comprising a great variety of mixing units. The structural design and/or implementation of the retaining lip can be adapted to respective shapes of the container opening or of the container wall inclination or container wall curvature. The details shown on the basis of the individual embodiments can be exchanged for one another. A fastening flange formed on the retaining lip can, in addition, also be provided in the case of the embodiments of FIGS. 1 to 6. Furthermore, it may e.g. suffice to configure the retaining lip such that only the area of its free upper edge is elastically flexible. This kind of structural design could advantageously be used e.g. in the case of the embodiment according to FIG. 12.

1. A feed mixer with a mixing container comprising a container wall with an opening delimited by an edge, said opening having associated therewith a retaining means, wherein the retaining means
includes a retaining lip consisting of an elastically flexible material extending, at least in certain sections thereof, inwards and projecting beyond the opening.

2. A feed mixer according to claim 1, wherein the retaining lip extends, at least in certain sections thereof, at an angle (α) between 10° and 50°, in particular 20° and 40°, in particular 25° and 35°, and in particular 30° relative to the vertical (V).

3. A feed mixer according to claim 1, wherein the retaining lip extends annularly around the opening.

4. A feed mixer according to claim 1, wherein the retaining lip comprises a plurality of sections connected to one another via motion compensating means.

5. A feed mixer according to claim 1, wherein the retaining lip is configured as a plain strip.

6. A feed mixer according to claim 1, wherein the retaining lip is configured as a profile strip.

7. A feed mixer according to claim 1, wherein the retaining lip is, at least in certain sections thereof, configured as part of an envelope of a cone.

8. A feed mixer according to claim 1, wherein the retaining lip is configured as a profile strip comprising a first, cylindrical area (210a) and a second area configured as part of an envelope of a cone.

9. A feed mixer according to claim 1, wherein the retaining lip is, at least in certain areas thereof, supported by a spring element.

10. A feed mixer according to claim 1, wherein the retaining lip is provided with a reinforcing means in the area of its free end.

11. A feed mixer according to claim 1, wherein the retaining means includes a fastening means for attaching the retaining lip to the container wall.

12. A feed mixer according to claim 10, wherein the fastening means is configured for releasably attaching the retaining lip.

13. A feed mixer according to claim 11, wherein the fastening means is provided with a buttoning means for attaching the retaining lip.

14. A feed mixer according to claim 1, wherein a support surface is provided, which abuts on one side of the retaining lip.

15. A feed mixer according to claim 13, wherein the support surface extends at an angle (α) relative to the vertical (V).
